(19) United States
(12) Patent Application Publication
(10) Pub. No.: US 2024/0332840 A1
(43) Pub. Date: Oct. 3, 2024

(54) WIRE CONNECTOR

(71) Applicant: BELLWETHER ELECTRONIC CORP., Taoyuan City (TW)

(72) Inventor: Ming-Hsun Yang, Taoyuan City (TW)

(21) Appl. No.: 18/396,742

(22) Filed: Dec. 27, 2023

Related U.S. Application Data
(60) Provisional application No. 63/455,563, filed on Mar. 30, 2023.
(60) Provisional application No. 63/523,493, filed on Jun. 27, 2023.

(30) Foreign Application Priority Data
Aug. 21, 2023 (TW) 112131297

(51) Int. Cl. H01R 12/79

(52) U.S. Cl. CPC H01R 12/79

(57) ABSTRACT

A wire connector, configured to be mated with a board connector, including an insulating body, at least one first connecting plate, at least one second connecting plate, and two side plate structures is provided. The insulating body has an end surface. The at least one first connecting plate protrudes outward from the end surface of the insulating body. The at least one second connecting plate protrudes outward from the end surface of the insulating body. The two side plate structures are respectively disposed on two opposite sides of the end surface and perpendicular to the end surface. The two side plate structures are partially inserted into the insulating body. When the wire connector is inserted into the board connector, the two side plate structures can prevent the wire connector from being inserted or removed from the board connector in a tilted position.

### CROSS-REFERENCE TO RELATED PATENT APPLICATION

This application claims the benefit of priority to Taiwan Patent Application No. 112131297 filed on Aug. 21, 2023, and the benefit of priorities to the U.S. Provisional Patent Application Ser. No. 63/455,563 filed on Mar. 30, 2023 and Ser. No. 63/523,493 filed on Jun. 27, 2023. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a wire connector, and more particularly to a wire connector that includes two different connecting tongue types.

### BACKGROUND OF THE DISCLOSURE

A conventional board connector may have two connecting slots of different types (e.g., a power connecting slot and a signal connecting slot). During the process of separating a mating conventional wire connector from the conventional board connector, due to the inconsistent frictional force required for different connecting slots, a situation where one end of the conventional wire connector has completely detached from the conventional board connector, while the other end of the conventional wire connector has not yet fully disconnected from the conventional board connector can often occur. As a result, the conventional wire connector as a whole will appear to be in a tilted state, and the related connection board of the conventional wire connector is easily damaged.

### SUMMARY OF THE DISCLOSURE

In response to the above-referenced technical inadequacies, the present disclosure provides a wire connector that has two different types of connecting slots, and can improve on a problem of a deviation occurring during the process of detaching the wire connector from the board connector (which can lead to structural damage to the wire connector).

In order to solve the above-mentioned problems, one of the technical aspects adopted by the present disclosure is to provide a wire connector for be mated with a board connector. The wire connector includes an insulating body, at least one first connecting plate, at least one second connecting plate, and two side plate structures. The insulating body has an end surface. The at least one first connecting plate protrudes outward from the end surface of the insulating body. The at least one second connecting plate protrudes outward from the end surface of the insulating body. The two side plate structures are respectively disposed on two opposite sides of the end surface of the insulating body and perpendicular to the end surface. The two side plate structures are partially inserted into the insulating body.

Therefore, by virtue of the two side plate structures, when the wire connector is inserted into or removed from the board connector, the wire connector can be constrained by the two side plate structures and cannot easily rotate relative to the board connector. As a result, the wire connector is not likely to be tilted, and the problem of damage to the relevant connecting plates of the wire connector can be greatly improved.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view of a connector assembly in a mated state according to a first embodiment of the present disclosure;

FIG. 2 is a schematic view of the connector assembly in an unmated state according to the first embodiment of the present disclosure;

FIG. 3 is a schematic top view of a board connector of the connector assembly according to the first embodiment of the present disclosure;

FIG. 4 is a schematic view of a wire connector of the connector assembly according to the first embodiment of the present disclosure;

FIG. 5 is a schematic partial cross-sectional view of the connector assembly according to the first embodiment of the present disclosure;

FIG. 6 is a schematic view of the connector in a mated state assembly according to a second embodiment of the present disclosure;

FIG. 7 is a schematic operational view of the wire connector of the connector assembly according to the second embodiment of the present disclosure;

FIG. 8 is a schematic view of the connector assembly in an unmated state according to the second embodiment of the present disclosure;

FIG. 9 is a schematic view of the wire connector of the connector assembly in a unmated state according to the second embodiment of the present disclosure;

FIG. 10 is a schematic view of the wire connector of the connector assembly according to a third embodiment of the present disclosure;

FIG. 11 is a schematic partial view of the wire connector of the connector assembly in an unmated state according to the third embodiment of the present disclosure; and

FIG. 12 is a schematic partial view of the wire connector of the connector assembly in an unmated state according to a fourth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein substantially have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

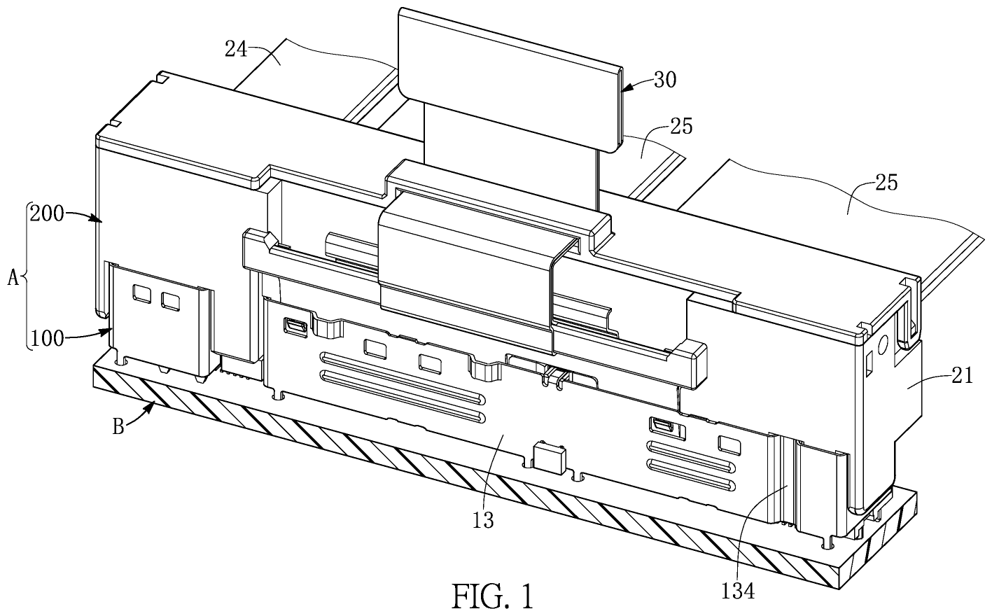

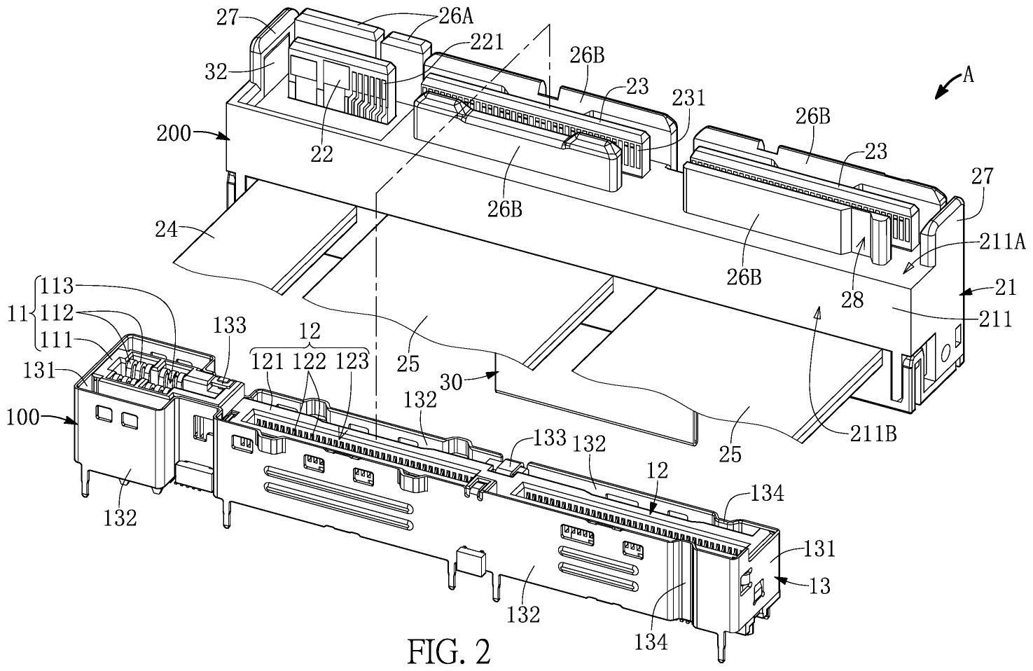

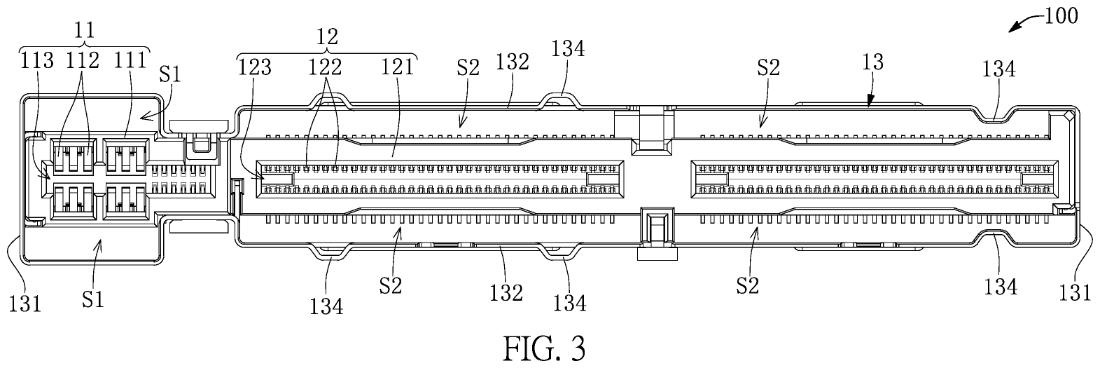

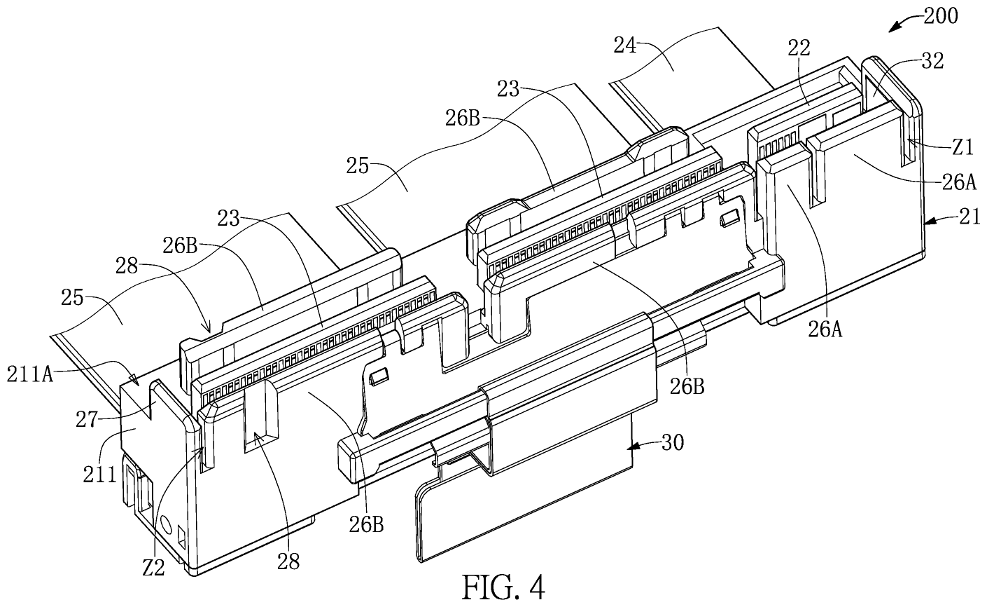

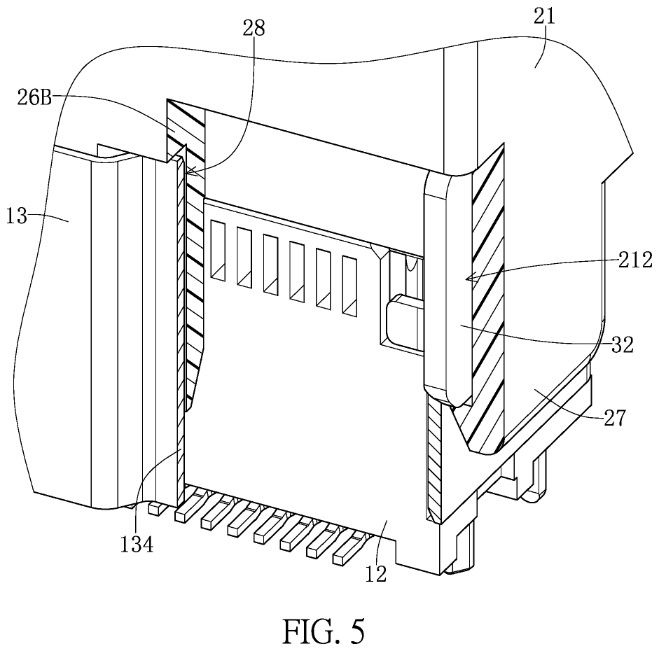

Referring to FIG. 1 to FIG. 5, FIG. 1 is a schematic view of a connector assembly in a mated state according to a first embodiment of the present disclosure, FIG. 2 is a schematic view of the connector assembly in an unmated state according to the first embodiment of the present disclosure, FIG. 3 is a schematic top view of a board connector of the connector assembly according to the first embodiment of the present disclosure, FIG. 4 is a schematic view of a wire connector of the connector assembly according to the first embodiment of the present disclosure, and FIG. 5 is a schematic partial cross-sectional view of the connector assembly according to the first embodiment of the present disclosure.

The connector assembly A of the present disclosure includes a board connector 100 and a wire connector 200. The board connector 100 is configured to be mounted on a circuit board B. The board connector 100 in the present embodiment includes a first connecting seat 11, two second connecting seats 12, and a metal shell 13. In practical applications, the board connector 100 can include at least one first connecting seat 11 and at least one second connecting seat 12, or the board connector 100 can include three or more different connecting seats, either integrally formed or independently connected through a snap-fit mechanism. The quantity of the first connecting seats 11 and the second connecting seats 12 included in the board connector 100 is not limited to the configuration shown in drawings of the present embodiment. The first connecting seat 11 and the two second connecting seats 12 can be arranged in a row on the circuit board B. However, the arrangement of the first connecting seat 11 and the two second connecting seats 12 on the circuit board B is not limited to the configuration shown in the drawings.

The first connecting seat 11 includes a first insulating base 111 disposed on the circuit board B, and a plurality of first connection terminals 112 that are disposed in the first insulating base 111. The first connection terminals 112 and the first insulating base 111 together form a first connecting slot 113. Each of the two second connecting seats 12 includes a second insulating base 121 disposed on the circuit board B, and a plurality of second connection terminals 122 that are disposed in the second insulating base 121. The second connection terminals 122 and the second insulating base 121 together form a second connecting slot 123.

The first connecting slot 113 is not the same as the second connecting slot 123. For example, in one of the embodiments, the first connecting slot 113 of the first connecting seat 11 is used to transmit power (including power-related signals), and the second connecting slot 123 of each of the two second connecting seats 12 is used to transmit signals. In other words, the quantity of the first connection terminals 112 included in the first connecting seat 11 and/or the outer appearance of at least a part of the first connection terminals 112 may differ from the quantity of the second connection terminals 122 included in the two second connecting seats 12 and/or the outer appearance of at least a part of the second connection terminals 122, but the specific uses of the first connecting seat 11 and the two second connecting seats 12 are not limited thereto. The first connecting slot 113 and the second connecting slot 123 are arranged in a straight line, that is, the first connecting slot 113 and the second connecting slot 123 are on the same plane.

The first connecting seat 11 and the two second connecting seats 12 are surrounded by the metal shell 13. The metal shell 13 can be exemplified to include two first side walls 131 (i.e., two short side walls), two second side walls 132 (i.e., two long side walls), and a plurality of clamping structures 133. Two ends of each of the two first side walls 131 are respectively connected to two ends of the two second side walls 132, the two first side walls 131 are arranged facing each other, and the two second side walls 132 are arranged facing each other. The two first side walls 131 and the two second side walls 132 may together form a substantially closed structure. The outer appearance and size of the metal shell 13 can be adjusted according to the quantity, shape and size of the first connecting seat 11 and the two second connecting seats 12. However, the present disclosure is not limited thereto.

The clamping structures 133 are disposed on at least one of the first insulating base 111 of the first connecting seat 11, the second insulating bases 121 of one of the two second connecting seats 12, a connecting portion between the first insulating base 111 and the adjacent second insulating base 121, and a connecting portion between the adjacent second insulating bases 121. The metal shell 13 is connected to the first connecting seat 11 and the two second connecting seats 12 through the clamping structures 133. The metal shell 13 can also include a plurality of pins, and the pins are used to be fixed on the circuit board B. The metal shell 13 can be electrically connected to a ground of the circuit board through the pins. In one of the embodiments when the metal shell 13 is grounded through the circuit board B, the metal shell 13 may have an electromagnetic shielding function.

The metal shell 13 is arranged around the first connecting seat 11 and the two second connecting seats 12, with one or more gaps between them. Specifically, at least one first gap S1 is between the metal shell 13 and the first insulating base 111 of the first connecting seat 11, and at least one second gap S2 is also between the metal shell 13 and the second insulating base 121 of one of the two second connecting seats 12. In the present embodiment, two long side walls of the metal shell 13 and two long side walls of the first connecting seat 11 respectively have the first gap S1 there-between, and the two long side walls of the metal shell 13 and two long side walls of each of the second connecting seat 12 respectively have the second gap S2 there-between.

The metal shell 13 can include a plurality of first guide structures 134. The first guide structures 134 may be formed on the two second side walls (long side walls) 132 of the metal shell 13, and the first guide structures 134 may be disposed substantially facing each other. Moreover, the first guide structures 134 may be disposed adjacent to at least one of the two second connecting seats 12. In other words, the metal shell 13 can have the first guide structures 134 formed in a section adjacent to the two second connecting seats 12. Each of the first guide structures 134 can be exemplified as being convex structures formed by the inward bending of the metal shell 13, or a concave structure formed by the outward bending of the metal shell 13. The outer appearance, forming method and setting position of the first guide structures 134 are not limited thereto. It should be noted that the first guide structures 134 can also be disposed adjacent to each of the two second connecting seats 12, or at least one of the first guide structures 134 may also be disposed adjacent to the first connecting seat 11.

In a preferred one of the embodiments, the metal shell 13 may include an even number of the first guide structures 134. One of the two second side wall 132 is provided with half the quantity of first guide structures 134, and the other second side wall 132 is provided with the other half of the first guide structures 134. Any one of the first guide structures 134 is arranged facing another one of the first guide structures 134.

The wire connector 200 is used to be inserted into the board connector 100. In the present embodiment, the wire connector 200 includes an insulating body 21, a first connecting plate 22, two second connecting plates 23, a first ribbon wire 24, two second ribbon wires 25, a plurality of inner limiting structures, two anti-tilt insertion structures 27, and two second guide structures 28.

The first connecting plate 22 and the two second connecting plates 23 are printed wire boards, and are arranged in a row (i.e., the first connecting plate 22 and the two second connecting plates 23 are on the same plane). The first connecting plate 22 has a plurality of first gold fingers 221, and each of the two second connecting plates 23 has a plurality of second gold fingers 231. The first gold fingers 221 may be formed on a single side or both sides of the first connecting plate 22, and the second gold fingers 231 may be formed on a single side or both sides of one of the two second connecting plates 23. The quantity of the first gold fingers 221 included in the first connecting plate 22 is different from the quantity of the second gold fingers 231 included in each of the two second connecting plates 23, or a width of at least one of the second gold fingers 231 is different from a width of at least one of the first gold fingers 221.

The insulating body 21 may include an end portion 211, and front ends of the first connecting plate 22 and the two second connecting plates 23 protrude from an end surface 211A of the end portion 211. Each of the first connecting plate 22 and the two second connecting plates 23 may be disposed on and perpendicular to the end surface 211A. The inner limiting structures may be formed by extending outward from the end surface 211A, and the inner limiting structures are substantially plate-shaped.

The first ribbon wire 24 is electrically connected to the first gold fingers of the first connecting plate 22, and the second ribbon wires 25 are electrically connected to the second gold fingers of the two second connecting plates 23. The first ribbon wire 24 and the second ribbon wires 25 are side out wires, and protrude outward from a side surface 211B adjacent to the end surface 211A of the insulating body 21. That is, the first ribbon wire 24 and the second ribbon wires 25 may be substantially perpendicular to the first connecting plate 22 and the two second connecting plates 23.

When the wire connector 200 and the board connector 100 are mated with each other, the first connecting plate 22 and the two second connecting plates 23 are correspondingly inserted into the first connecting slot 113 and the second connecting slots 123, so that the first connecting plate 22, the first ribbon wire 24, the first connection terminals 112 and the circuit board B can be electrically connected, and the two second connecting plates 23, the second ribbon wires 25, the second connection terminals 122 and the circuit board B can also be correspondingly and electrically connected.

A plurality of limiting structures may be formed by extending outward from the end surface 211A of the insulating body 21, the limiting structures can be arranged in parallel with the first connecting plate 22, and the limiting structures can be located on one side or two opposite sides of the first connecting plate 22 and the two second connecting plates 23. For illustration purposes, the inner limiting structures in the present embodiment are defined as first inner limiting structures 26A and second inner limiting structures 26B according to the locations of the inner limiting structures. Two first inner limiting structures 26A may be arranged in a straight line, and the two first inner limiting structures 26A may be located on one side of the first connecting plate 22. For example, each of the two first inner limiting structures 26A may be located between the first connecting plate 22 and the first ribbon wire 24. Two second inner limiting structures 26B may be disposed on both sides of one of the two second connecting plates 23, and another two of the second inner limiting structures 26B may be disposed on both sides of another one of the two second connecting plates 23.

When the wire connector 200 and the board connector 100 are connected to each other, each of the first inner limiting structures 26A and the second inner limiting structures 26B correspond in position to the first gap S1 and the second gap S2, respectively. By virtue of “the first inner limiting structures 26A and the second inner limiting structures 26B”, the wire connector 200 can achieve anti-fooling and guiding effects during the process of inserting into the board connector 100. Thereby, the first connecting plate 22 and the two second connecting plates 23 are assisted to correctly insert into the first connecting slot 113 and the second connecting slots 123 along a mating direction. The size, outer appearance, quantity, and location of the first inner limiting structures 26A and the second inner limiting structures 26B can be adjusted according to practical requirements, and the present disclosure is not limited thereto.

The two anti-tilt insertion structures 27 can be exemplified as being formed by extending outward from the end surface 211A, and can be exemplified as being located on both sides of the end portion 211 of the insulating body 21. A reserved space is between each of the two anti-tilt insertion structures 27 and an adjacent one of the inner limiting structures. Specifically, a first reserved space Z1 is between one of the two anti-tilt insertion structures 27 and/or an adjacent one of the first inner limiting structures 26A, and a second reserved space Z2 is between the other one of the two anti-tilt insertion structures 27 and an adjacent one of the second inner limiting structures 26B. Each of the reserved spaces (i.e., the first reserved space Z1 and the second reserved space Z2) is used to accommodate a part of the metal shell 13. It should be noted that the two anti-tilt insertion structures 27 extend from the end surface 211A, so the two anti-tilt insertion structures 27 can be regarded as a part of the insulating body 21.

The wire connector 200 also includes two side plate structures 32. The two side plate structures 32 are plate-shaped structures and are respectively located on a left side and a right side of the wire connector 200. The two side plate structures 32 are perpendicular to the first connecting plate 22 and the second connecting plate 23, and the two side plate structures 32 are perpendicularly disposed on the end surface 211A. The two side plate structures 32 may be disposed on two opposite sides of the end surface 211A, and the two side plate structures 32 may be disposed facing each other. When the wire connector 200 is inserted into the board connector 100, the two side plate structures 32 are correspondingly located on an outer side of the metal shell 13. A part of each of the two side plate structures 32 may be disposed in the insulating body 21.

By virtue of the two side plate structures 32, an overall structural strength of the two anti-tilt insertion structures 27 can be effectively reinforced. In this way, during the process of inserting or removing the wire connector 200 from the board connector 100, the two anti-tilt insertion structures 27 will be less prone to damage (such as deformation or fracture). In practical applications, the two side plate structures 32 can be exemplified as being made of metal materials, but the present disclosure is not limited thereto. Any material that is capable of strengthening the structural strength of the two anti-tilt insertion structures 27 can be used as the material of the two side plate structures 32.

Referring to FIG. 1 and FIG. 2, when the wire connector 200 is connected to the board connector 100, and the two anti-tilt insertion structures 27 and/or the two side plate structures 32 correspond in position to outer sides of the two ends (i.e., the two first side walls 131) of the metal shell 13, the two anti-tilt insertion structures 27 and/or the two side plate structures 32 are used to prevent the wire connector 200 from being inserted or removed from the board connector 100 in a tilted position.

The second guide structures 28 are used to be guided with the first guide structures 134. The second guide structures 28 included in the wire connector 200 correspond in position to the first guide structures 134 included in the board connector 100, and the quantity of the second guide structure 28 can be equal to or different from the first guide structures 134 (e.g., the same or fewer in quantity).

In the present embodiment, two second guide structures 28 may be respectively formed on two of the second inner limiting structures 26B, and the two second guide structures 28 are disposed adjacent to one of the two second connecting plates 23. The two second guide structures 28 may be located at an end of the wire connector 200 opposite to where the first connecting plate 22 is positioned. That is, the two second guide structures 28 and the first connecting plate 22 may be approximately located at a left end and a right end of the wire connector 200.

The second guide structures 28 may be groove structures formed on outer sides of the second inner limiting structures 26B and the first guide structures 134 are a convex structure in the second gap S2. When the wire connector 200 is inserted into the board connector 100, the first guide structures 134 will cooperate with the second guide structures 28. By virtue of the first guide structures 134 and the second guide structures 28, when the wire connector 200 is inserted into the board connector 100, the first connecting plate 22 and the second connecting plates 23 can be inserted into the first connecting slot 113 and the second connecting slots 123 relatively easily and correctly.

Correspondingly, when the wire connector 200 is detached from the board connector 100, each of the second guide structures 28 will move relative to a corresponding one of the first guide structures 134. Therefore, the moving direction of the wire connector 200 relative to the board connector 100 can be effectively limited, so that the wire connector 200 can detach from the board connector 100 in a vertical direction (i.e., in the opposite direction of the mating direction). For this reason, a structure of the wire connector 200 can effectively avoid damage due to any improper force during the process of being detached from the board connector 100.

In addition, in one of the embodiments where the first connecting seat 11 and the second connecting seats 12 are respectively used to transmit power and signals, due to that the quantity of the first connection terminals 112 included in the first connecting seat 11 is small, and the first connection terminals 112 are relatively wider, while the quantity of each of the second connection terminals 122 included in the second connecting seat 12 is large, and the first connection terminals 112 are relatively narrower, the force required for the first connecting plate 22 to detach from the first connecting slot 113 is greater than the force required for each of the second connecting plates 23 to detach from the second connecting slot 123. When the wire connector 200 is detached from the board connector 100, both ends of the wire connector 200 can be detached from of the board connector 100 at approximately the same time through the first guide structures 134 and the second guide structures 28.

In the above situation, a height of each of the first guide structures 134 may be approximately the same as a height of the metal shell 13, or may be less than half the height of the metal shell 13 (e.g., the first guide structures 134 can also be located only within an upper half of the metal shell 13). When the wire connector 200 is detached from the board connector 100, the first guide structures 134 and the second guide structures 28 will cooperate with each other to jointly limit a movement of the wire connector 200 relative to the board connector 100. The two anti-tilt insertion structures 27 can be less easily damaged through the protection of the two side plate structures 32.

In the above situation, by virtue of “the first guide structures 134 and the second guide structures 28”, when the wire connector 200 is detached from the board connector 100, the wire connector 200 can also effectively prevent damage to the two anti-tilt insertion structures 27 due to the deviation of the wire connector 200.

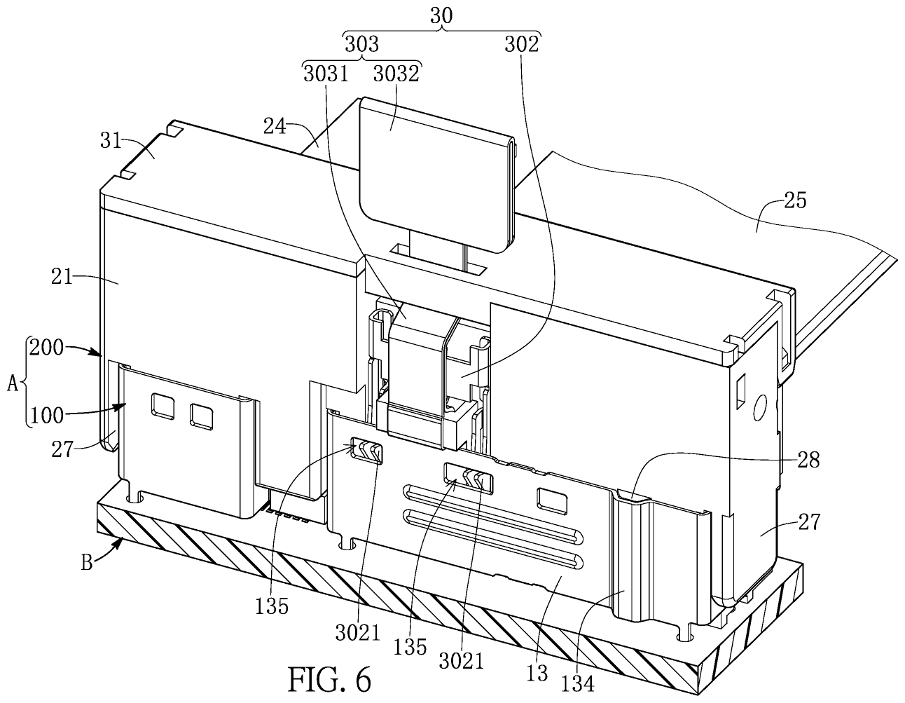

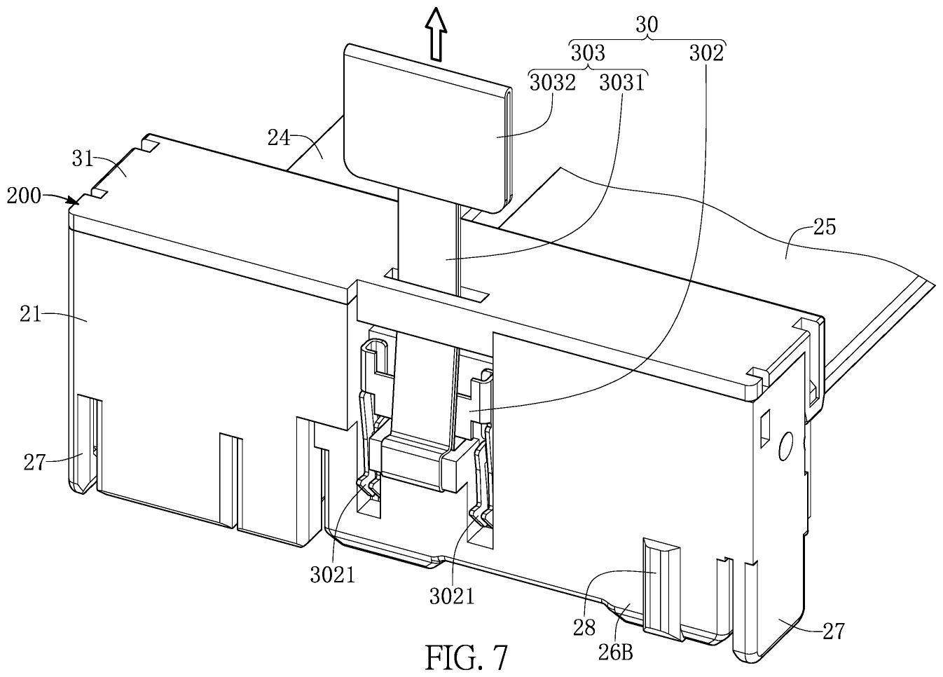

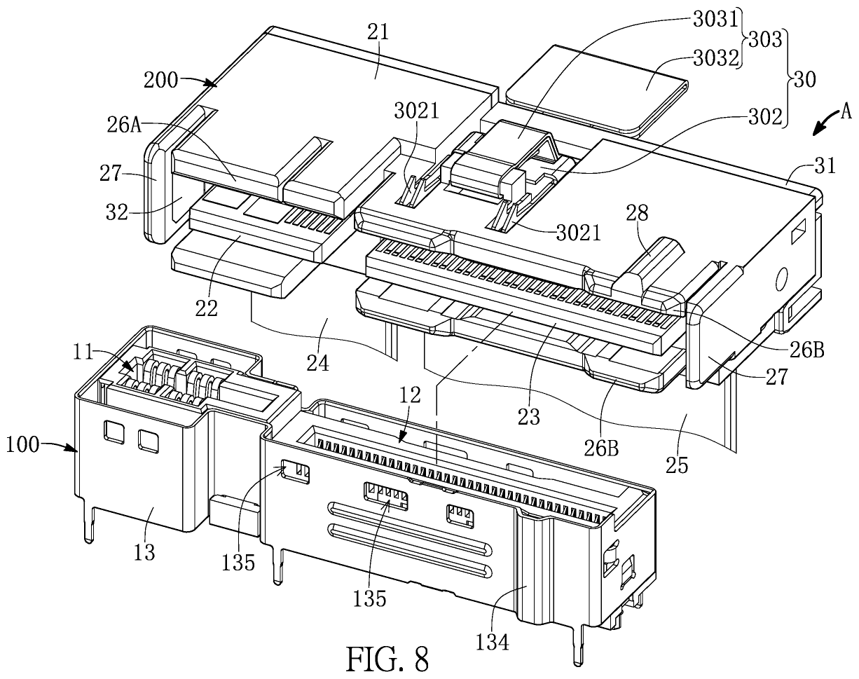

Referring to FIG. 6 to FIG. 9, FIG. 6 is a schematic view of the connector assembly in a mated state according to a second embodiment of the present disclosure, FIG. 8 is a schematic view of the connector assembly in an unmated state according to the second embodiment of the present disclosure, FIG. 7 is a schematic operational view of the wire connector according to the present embodiment.

One difference between the present embodiment and the second embodiment or the third embodiment mainly resides in that one of the second guide structures 28 provided on the outer side of one of the inner limiting structures 26B of the wire connector 200 (opposite to the side facing the second connecting plate 23) may be a solid columnar structure.

Another difference between the present embodiment and the second embodiment or the third embodiment mainly resides in that the board connector 100 includes a single first connecting seat 11 and a single second connecting seat 12, and the wire connector 200 includes a single first connecting plate 22 and a single second connecting plate 23.

The metal shell 13 of the board connector 100 also includes a plurality of first buckle structures 135, and each of the first buckle structures 135 can be a through hole or a groove on the metal shell 13. The first buckle structures 135 are correspondingly disposed on the first connecting seat 11 and/or the second connecting seat 12. The wire connector 200 also includes an operating mechanism 30, and the operating mechanism 30 includes an elastic component 302 and a drawstring 303. The elastic component 302 is disposed on an outside surface of the inner limiting structure 26B. The elastic component 302 includes a plurality of second buckle structures 3021, and the second buckle structures 3021 may be outward hooks or bumps. The drawstring 303 includes a drawstring body 3031 and a holding portion 3032, one end of the drawstring body 3031 is fixed on the insulating body 21, and the other end of the drawstring body 3031 is connected to the holding portion 3032. A part of the drawstring body 3031 is located in an outer side of the elastic component 302.

When the wire connector 200 and the board connector 100 are connected to each other, the first buckle structures 135 and the second buckle structures 3021 engage with each other. When the holding portion 3032 of the drawstring 303 is held and pulled along a direction away from the insulating body 21, a segment of the drawstring 303 located on the elastic component 302 causes the elastic component 302 to move inwardly (i.e., a free end of the elastic component 302 is pressed inwardly), so that the elastic component 302 undergoes elastic deformation and the second buckle structures 3021 will correspondingly move away from the first buckle structures 135. Accordingly, the second buckle structures 3021 will no longer engage with the first buckle structures 135.

By virtue of the first buckle structures 135 and the second buckle structures 3021, the wire connector 200 and the board connector 100 can be connected more firmly. Moreover, through the design of the drawstring 303, users can easily and quickly disengage the second buckle structures 3021 from the first buckle structures 135.

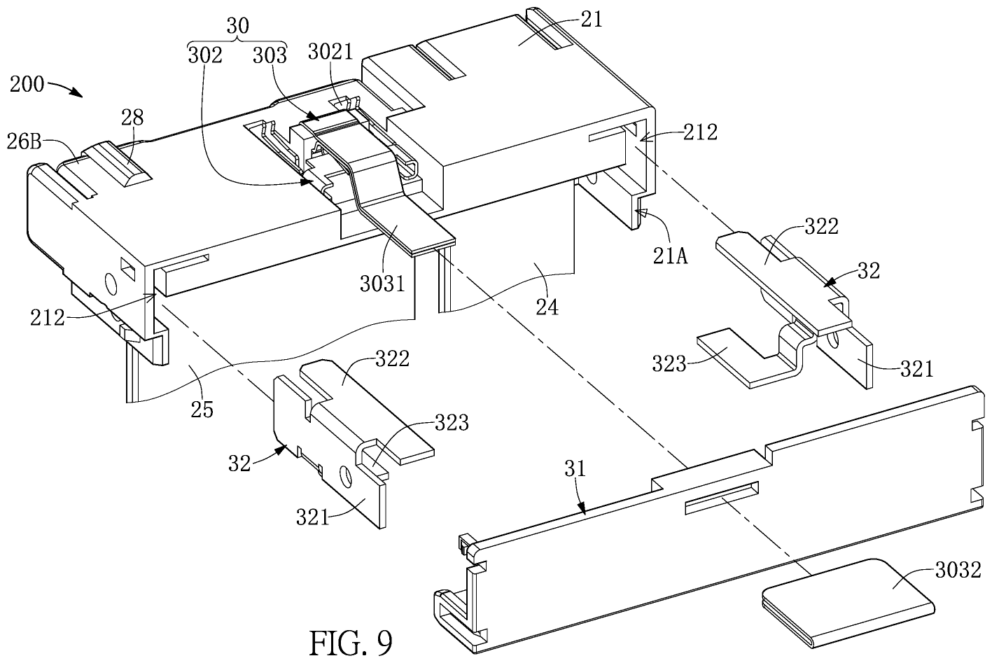

Referring to FIG. 8 and FIG. 9, the wire connector 200 may also include a cover body 31. The cover body 31 is detachably disposed on a rear end 21A of the insulating body 21 of the wire connector 200, and a front end 21B of the insulating body 21 is provided with a first connecting plate 22 and a second connecting plate 23. The insulating body 21 also includes two accommodating grooves 212 located at the rear end 21A. A part of each of the accommodating grooves 212 can extend into the two anti-tilt insertion structures 27, respectively.

Parts of the two side plate structures 32 can be correspondingly engaged and disposed in the two accommodating grooves 212. In the present embodiment, the two side plate structures 32 can be correspondingly inserted into the two accommodating grooves 212 from the rear end 21A of the insulating body 21. When each of the two side plate structures 32 is disposed in the accommodating groove 212, the parts of the two side plate structure 32 will be correspondingly located in the two anti-tilt insertion structures 27, and an exposed surface of the side plate structure 32 from the inside of the anti-tilt insertion structure 27 is flush with a surface of the anti-tilt insertion structure 27. Thereby, the overall structural strength of the anti-tilt insertion structure 27 can be reinforced.

Each of the two side plate structures 32 can be exemplified to include a structural body 321, a first engaging portion 322, and a second engaging portion 323. The structural body 321 is substantially a plate-like structure, and two opposite sides thereof may extend in the same direction to form a first engaging portion 322, and a second engaging portion 323, respectively. The first engaging portion 322 may be disposed substantially facing the second engaging portion 323, and the structural body 321, the first engaging portion 322, and the second engaging portion 323 may jointly form a substantially U-shaped structure. The outer appearance and dimensions of the first engaging portion 322 and the second engaging portion 323 can be adjusted according to practical requirements. The illustration in the drawings is just one example of a possible configuration.

An opening of each of the two accommodating grooves 212 may be located at the rear end 21A of the insulating body 21, and each of the two side plate structures 32 may be inserted into the insulating body 21 from the rear end 21A of the insulating body 21. The structural body 321, the first engaging portion 322 and the second engaging portion 323 can all be disposed in the insulating body 21 through the accommodating groove 212. A connection strength between the two side plate structure 32 and the insulating body 21 can be reinforced through the first engaging portion 322 and the second engaging portion 323. Naturally, in different embodiments, the two side plate structures 32 may have no the first engaging portion 322 and/or the second engaging portion 323. The manner in which the two side plate structures 32 is fixed in the accommodating groove 212 is not limited thereto. For example, the two side plate structures 32 can be locked and fixed in the accommodating groove 212 through the structural body 321, the first engaging portion 322 and the second engaging portion 323 in a tight fitting manner. It should be noted that in the present embodiment, each of the two side plate structures 32 is detachably fixed in the insulating body 21 through the accommodating groove 212 of the insulating body 21, but the two side plate structures 32 are not limited to being detachably fixed in the insulating body 21. In different embodiments, the insulating body 21 and the two side plate structures 32 can also be formed by insert molding, or the insulating body 21 and the two side plate structures can also be formed by double-material injection.

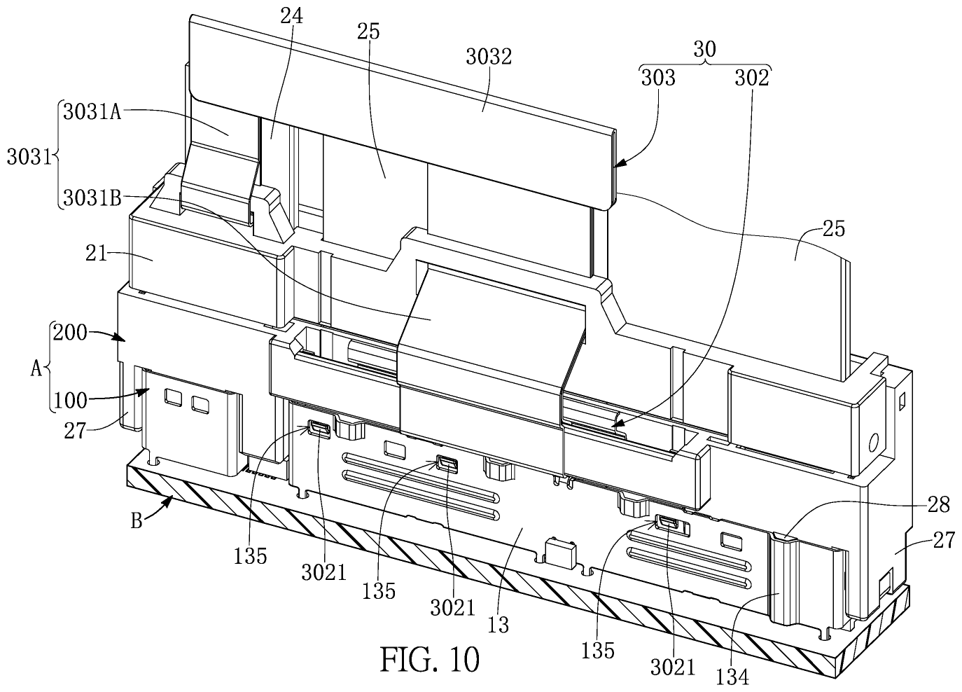

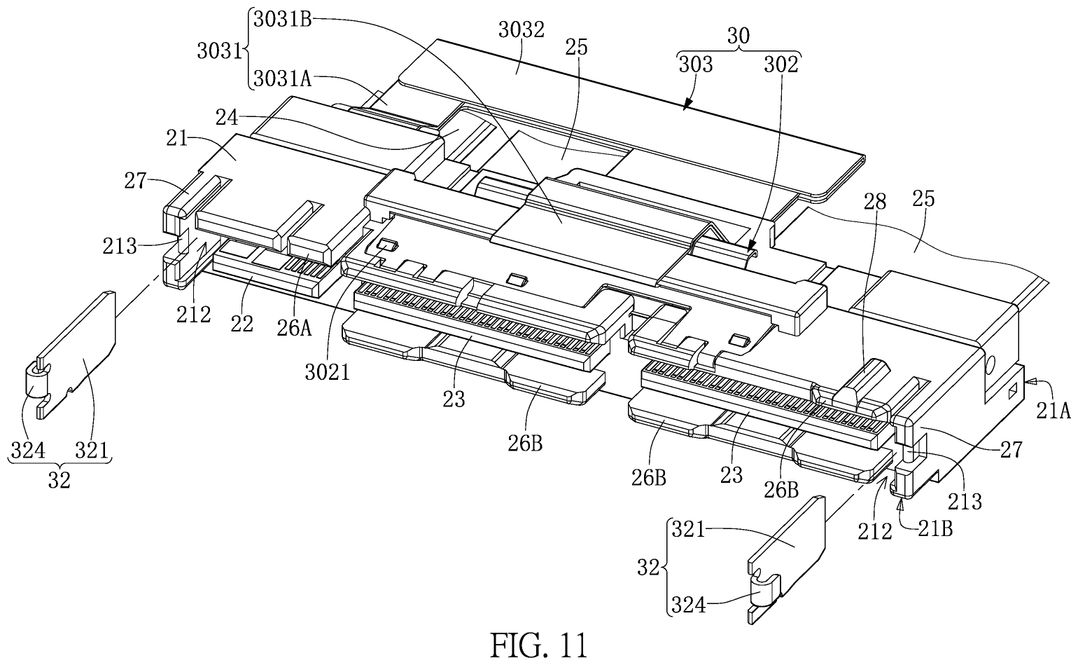

Referring to FIG. 10 and FIG. 11, FIG. 10 is a schematic view of the wire connector of the connector assembly according to the third embodiment, and FIG. 11 is a schematic partial view of the wire connector of the connector assembly in an unmated state according to the present embodiment.

One difference between the present embodiment and any one of the previous embodiments mainly resides in that the drawstring body 3031 of the operating mechanism 30 includes a first section 3031A and a second section 3031B. One of two ends of the first section 3031A is fixed near the location where the first connecting plate 22 is arranged on the insulating body 21, and one of two ends of the second section 3031B is fixed near the location where the second connecting plate 23 is arranged on the insulating body 21. Another one of the two ends of the first section 3031A and another one of the two ends of the second section 3031B are connected to the holding portion 3032. When the holding portion 3032 is pulled in a direction away from the board connector 100, a portion of the force will cause the disengagement of the first buckle structures 135 from the second buckle structures 3021, while another portion of the force will assist the first connecting plate 22 in disengaging from the first connecting seat of the board connector 100.

Referring to FIG. 3 and FIG. 11, in one of the embodiments where the first connecting seat 11 of the board connector 100 is used for transmitting power and the second connecting seat 12 is used for transmitting signals, by virtue of the first section 3031A and the second section 3031B, a central axis of the drawstring and a central axis of the wire connector 200 (or a central axis of the elastic component 302) can be laterally offset to compensate for uneven pulling forces. In the scenario where the user directly pulls the drawstring 303 to detach the wire connector 200 from the board connector 100, the first connecting plate 22 and the second connecting plate 23 contained in the wire connector 200 can substantially be simultaneously disengaged from the first connecting seat 11 and the second connecting seat 12.

On the contrary, if the drawstring 303 only includes the second section 3031B, in the scenario where the user directly pulls the drawstring 303 to detach the wire connector 200 from the board connector 100, the second connecting plate 23 may have been separated from the second connecting base 12, while the first connecting plate 22 is not completely disengaged from the first connecting seat 11. As a result, the structure of the wire connector 200 may be damaged.

Referring to FIG. 11, the difference between the present embodiment and any one of the previous embodiments mainly resides in that an opening of the accommodating groove 212 of the insulating body 21 of the wire connector 200 may be located at the front end 21B of the insulating body 21, and each of the two side plate structures 32 may be inserted into the insulating body 21 from the front end 21B of the insulating body 21.

Each of the two side plate structures 32 in the present embodiment includes a structural body 321 and a second fixed structure 324 located at the front end 21B, and the insulating body 21 may include a first fixing structure 213 located at the front end 21B of the insulating body 21. The structural body 321 of the side plate structures 32 is substantially a plate-like structure, and the second fixed structure 324 can engage with the first fixed structure 213, so that the structural body 321 is fixed or limited to the insulating body 21. The placement, dimensions, and outer appearance of the first fixed structure 213 and the second fixed structure 324 can be adjusted according to practical requirements. In different embodiments, the two side plate structures 32 in the present embodiment can also be configured with the first engaging portion and the second engaging portion that are mentioned in the previous embodiments. In different embodiments, the outer appearance of the two side plate structures 32 in the present embodiment can also be similar to the outer appearance of the two side plate structure shown in FIG. 9.

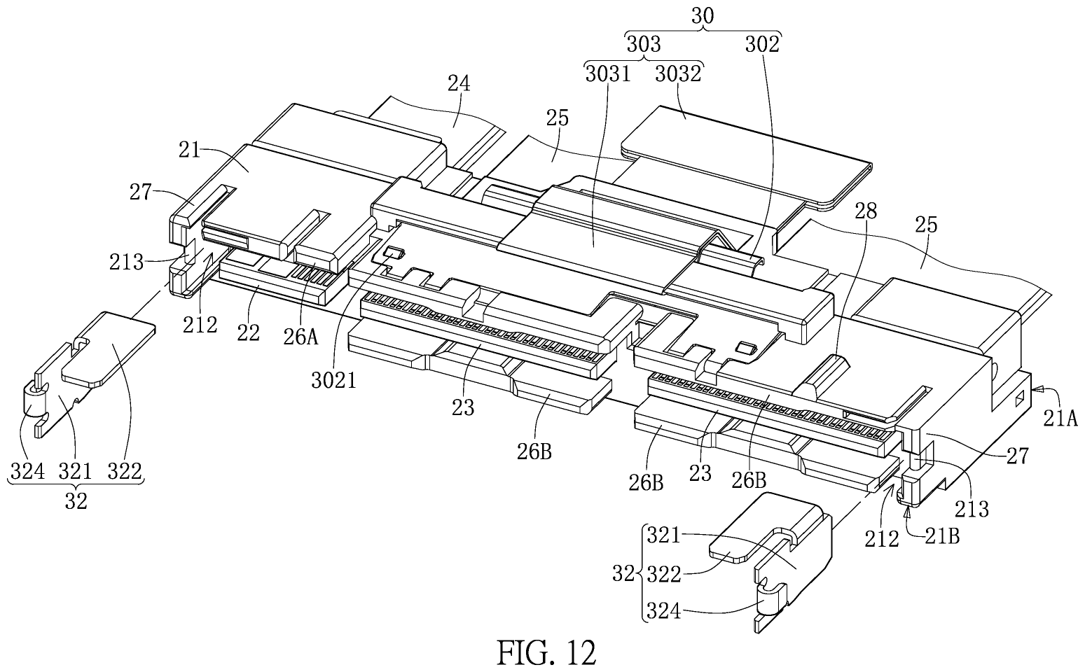

Referring to FIG. 12, FIG. 12 is a schematic partial view of the wire connector of the connector assembly in an unmated state according to a fourth embodiment of the present disclosure. The difference between the present embodiment and the embodiment in FIG. 11 mainly resides in that the two side plate structures 32 in the present embodiment also includes a first engaging portion 322. The first engaging portion 322 is connected to the structural body 321, and the first engaging portion 322 and the structural body 321 may together form a substantially L-shaped structure.

It is worth mentioning that in one of the practical applications of the present disclosure, the side plate structure in any of the above aspects can be made of a metal structure. A thickness of the side plate structure can be greater than or equal to 0.3 mm, and a part of the side plate structure is exposed on the inside of the anti-tilt insertion structure. When the wire connector and the board connector are connected to each other, the side plate structure can be in contact with the metal shell, and the side plate structure can be grounded through the metal shell. Through this configuration, the side panel structures can have the function of electromagnetic shielding. In practical applications, it is possible to achieve contact between the side plate structure and the metal shell during the connection of the wire connector and the board connector by changing the appearance and dimensions of the side plate structure.

In other embodiments, the side plate structure 32 can be inserted into the insulating body 21 from the front end 21B or the rear end 21A, as well as from an upper end or a lower end of the insulating body 21. Moreover, in the above embodiments, the side plate structure 32 is located on the inside of the anti-tilt insertion structure 27. However, in practical applications, the side plate structure 32 can also be positioned inside or outside of the anti-tilt insertion structure 27. Alternatively, the side plate structure 32 can directly serve as the anti-tilt insertion structure, meaning that the insulating body 21 does not have the anti-tilt insertion structure 27 as in the previous embodiments. Instead, one end of the side plate structure 32 is inserted into the accommodating groove 212 of the insulating body 21, while the other end protrudes from the front end of the insulating body 21 to function as the anti-tilt structure.

It should be noted that, in the above-mentioned embodiments, the terms “first,” “second,” and “inner” used to describe the first inner limiting structure, the second inner limiting structure, and external limiting structure are merely adjectives adopted for the convenience of explanation in the embodiments. In fact, the first inner limiting structure, the second inner limiting structure, and external limiting structure all belong to a single type of limiting structure.

In conclusion, in the connector assembly provided by the present disclosure, by virtue of “the first guide structure, the second guide structure, the operating mechanism, and the side plate structure,” whether used individually or in combination, it can prevent the components of the wire connector from easily getting damaged (e.g., bending, breaking) during the insertion or removal process from the board connector.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A wire connector for be mated with a board connector, comprising:
an insulating body having an end surface;
at least one first connecting plate protruding outward from the end surface of the insulating body;
at least one second connecting plate protruding outward from the end surface of the insulating body; and
two side plate structures being respectively disposed on two opposite sides of the end surface of the insulating body and perpendicular to the end surface, wherein the two side plate structures are partially inserted into the insulating body.

2. The wire connector according to claim 1, wherein two anti-tilt insertion structures extend from the two opposite sides of the end surface of the insulating body, respectively; and wherein the two side plate structures are disposed on one side or inside of the two anti-tilt insertion structures, respectively.

3. The wire connector according to claim 2, wherein a part of each of the two side plate structures are exposed on the inside of one of the two anti-tilt insertion structures; wherein, when the wire connector is connected to a board connector, the two side plate structures are configured to be in contact with a metal shell of the board connector.

4. The wire connector according to claim 3, wherein an exposed surface of the side plate structure is flush with a surface of the anti-tilt insertion structure.

5. The wire connector according to claim 2, wherein each of the two opposite sides of the insulating body has an accommodating groove, each of the two side plate structures is detachably disposed in the accommodating groove, and a part of each of the two side plate structures is located in a corresponding one of the two anti-tilt insertion structures.

6. The wire connector according to claim 5, wherein an opening of the accommodating groove is located at a front end or a rear end of the insulating body, and each of the two side plate structures is configured to be placed into the accommodating groove from the front end or the rear end of the insulating body.

7. The wire connector according to claim 6, comprising a cover body that is detachably disposed on the rear end of the insulating body.

8. The wire connector according to claim 1, wherein each of the two side plate structures is a metal structure.

9. The wire connector according to claim 1, wherein the two side plate structures are perpendicular to the at least one first connecting plate and the at least one second connecting plate.

10. The wire connector according to claim 1, wherein each of the two side plate structures includes a structural body and at least one engaging portion, wherein the structural body is a plate-like structure, and the at least one engaging portion is connected to the structural body, and wherein each of the two opposite sides of the insulating body has an accommodating groove, and the at least one engaging portion of each of the two side plate structures is disposed in the accommodating groove.

11. The wire connector according to claim 1, wherein each of the two opposite sides of the insulating body has an accommodating groove, and each of the two side plate structures is partially inserted into the accommodating groove.

12. The wire connector according to claim 1, wherein the at least one first connecting plate has a plurality of first gold fingers and the at least one second connecting plate has a plurality of second gold fingers, wherein a quantity of the first gold fingers is different from a quantity of the second gold fingers, or wherein a width of at least one of the first gold fingers is different from a width of at least one of the second gold fingers.
